(19) United States
(12) Patent Application Publication
(10) Pub. No.: US 2024/0327971 A1
(43) Pub. Date: Oct. 3, 2024

(54) THERMAL BARRIER COATINGS MADE FROM NZP CLASS OF CERAMICS WITH A CTE GREATER THAN 5 PPM/C

(71) Applicant: Solution Spray Technologies LLC, Storrs, CT (US)

(72) Inventors: Eric Jordan, Storrs, CT (US); Chen Jiang, Willimantic, CT (US); Rishi Kumar, Ashford, CT (US)

(21) Appl. No.: 18/194,617

(22) Filed: Mar. 31, 2023

(51) Int. Cl. C23C 14/08; C23C 4/134; C23C 24/04

(52) U.S. Cl. CPC C23C 14/083; C23C 4/134; C23C 14/082; C23C 14/086; C23C 24/04; F01D 5/288; F16L 59/16

(57) ABSTRACT

A thermal barrier coating for an internal combustion engine includes an insulating coating applied on engine valves and exhaust components, where a chosen material of the insulating coating comprises a material of a sodium zirconium phosphate (“NZP”) class of ceramics that has a coefficient of thermal expansion (“CTE”) greater than 5 ppm/C.

### STATEMENT OF FEDERALLY SPONSORED RESEARCH

This invention was made with Government support under DE-SC0019865 and DE-EE0007817 awarded by Department of Energy. The Government has certain rights to this invention.

### FIELD

Embodiments of methods and apparatuses are described to make thermal barrier coatings.

### BACKGROUND

Automobile and truck internal combustion (IC) engines dominate the ground transportation sector in the US (and globally), annually transporting 11 billion tons of freight and logging 3 trillion vehicle miles. Improvement to the fuel efficiency of IC engines reduces environmental impact and can yield large economic benefits, both to the end users (i.e., the operators of IC engine powered vehicles) and to the competitiveness of engine manufacturers across the world. Although U.S. federal regulations currently incentivize electric vehicles and the penetration of electric vehicles is expected to increase in the future, IC engines are anticipated to remain as the primary energy conversion technology in vehicle application to 2040 and beyond in nearly all projections.

In IC engines, a large fraction of the heat generated during combustion is transferred to the pistons, the head, and the cylinder liner, and ultimately dissipated by the engine coolant. These direct heat losses to the combustion chamber walls reduce the power generated, and consequently, the efficiency of IC engines. Thermal barrier coatings (TBCs) can be used to address this issue. By coating the engine components that define the combustion chamber with TBCs, heat losses can be substantially reduced, thereby providing higher temperatures and pressures after combustion and throughout expansion. The higher pressures during expansion increase work extraction improving thermal efficiency. In addition, low thermal inertia TBCs provide rapid surface temperature response which will reduce time to catalyst light-off, resulting in lower unburned hydrocarbon (UBHC) and carbon monoxide (CO) emissions during a cold-start. Embodiments described herein provide the above enhanced improvements.

It has been demonstrated by the inventors that the use of high-performance TBCs resulted in up to 2% relative improvement in thermal efficiency along with reduced UBHC emissions. These promising results were achieved by applying an advanced TBC to the piston surface only, due to the scope and timeline of the Phase I program; however it is expected that the efficiency benefits will be amplified by coating the remaining combustion chambers surfaces in addition to the piston. W have prioritized (1) identification of additional engine components with excellent potential for further increases in efficiency; (2) further enhancement of performance gains by optimizing coating thickness, thermal properties, and surface properties including roughness and catalytic properties; (3) cost reduction; (4) process robustness improvements; (5) more comprehensive testing to be able to present the best case for commercial adoption; and (6) demonstration and optimization of TBCs to achieve improvements in cold-start emissions performance. These priorities lie directly in line with the interests of major commercial engine manufacturers. The key to achieving the desired TBC performance is low thermal conductivity and low heat capacity; the novel coating developed performed extremely well in this regard.

### SUMMARY

The subject matter of the present application has been developed in response to the present state of the art, and in particular, in response to the problems and disadvantages associated with conventional thermal barrier coatings that have not yet been fully solved by currently available techniques. Accordingly, the subject matter of the present application has been developed to provide embodiments that overcome at least some of the shortcomings of prior art techniques.

Disclosed herein is a thermal barrier coating for an internal combustion engine. The thermal barrier coating includes an insulating coating applied on engine valves and exhaust components, where a chosen material of the insulating coating comprises a material of a sodium zirconium phosphate (“NZP”) class of ceramics that has a coefficient of thermal expansion (“CTE”) greater than 5 ppm/C. The preceding subject matter of this paragraph characterizes example 1 of the present disclosure.

The insulating coating is applied by a thermal deposition comprising one of plasma spray, flame spray, high velocity oxygen fuel spray, detonation gun spray, dip coating, or painting. The preceding subject matter of this paragraph characterizes example 2 of the present disclosure, wherein example 2 also includes the subject matter according to example 1, above.

An input of the insulating coating comprises one of powder or ingots. The preceding subject matter of this paragraph characterizes example 3 of the present disclosure, wherein example 3 also includes the subject matter according to any one of examples 1-2, above.

The insulating coating is applied by one of radio frequency (RF) sputtering deposition, or electron beam physical vapor deposition. The preceding subject matter of this paragraph characterizes example 4 of the present disclosure, wherein example 4 also includes the subject matter according to any one of examples 1-3, above.

The insulating coating comprises one of NaGe₂(PO₄)₃ and NaGe₂₋ₓTiₓ(PO₄)₃ with x between 0 and 1. The preceding subject matter of this paragraph characterizes example 5 of the present disclosure, wherein example 5 also includes the subject matter according to any one of examples 1-4, above.

The insulating coating comprises Ca_{0.5(1+x)}FeₓTi₂₋ₓ(PO₄)₃ where x is between 2.5 and 0. The preceding subject matter of this paragraph characterizes example 6 of the present disclosure, wherein example 6 also includes the subject matter according to any one of examples 1-5, above.

The insulating coating is applied by solution spray process or a suspension spray process. The preceding subject matter of this paragraph characterizes example 7 of the present disclosure, wherein example 7 also includes the subject matter according to any one of examples 1-6, above.

The insulating coating is applied by solution spray process or a suspension spray process. The preceding subject matter of this paragraph characterizes example 8 of the present disclosure, wherein example 8 also includes the subject matter according to any one of examples 1-7, above.

An input of the insulating coating comprises a liquid stock. The preceding subject matter of this paragraph characterizes example 9 of the present disclosure, wherein example 9 also includes the subject matter according to any one of examples 1-8, above.

The liquid stock is made by a soluble metal/metalloid compound and phosphates are made into two separate aqueous solutions that are mixed before use to avoid gelation. The preceding subject matter of this paragraph characterizes example 10 of the present disclosure, wherein example 10 also includes the subject matter according to any one of examples 1-9, above.

A thermal barrier coating for a gas turbine includes an insulating coating applied to hot section components of the gas turbine made of a superalloy where a chosen material of the insulating coating comprises a material of a sodium zirconium phosphate (“NZP”) class of ceramics that has a coefficient of thermal expansion (“CTE”) greater than 5 ppm/C. The preceding subject matter of this paragraph characterizes example 11 of the present disclosure.

The superalloy is a nickel-based superalloy. The preceding subject matter of this paragraph characterizes example 12 of the present disclosure, wherein example 12 also includes the subject matter according to example 11, above.

The hot section components comprise one of vanes, blades, combustors, or ducts. The preceding subject matter of this paragraph characterizes example 13 of the present disclosure, wherein example 13 also includes the subject matter according to any one of examples 11-12, above.

The insulating coating is applied by one of radio frequency (RF) sputtering deposition, or electron beam physical vapor deposition. The preceding subject matter of this paragraph characterizes example 14 of the present disclosure, wherein example 14 also includes the subject matter according to any one of examples 11-13, above.

The insulating coating comprises one of NaGe₂(PO₄)₃ and NaGe₂₋ₓTiₓ(PO₄)₃ with x between 0 and 1. The preceding subject matter of this paragraph characterizes example 15 of the present disclosure, wherein example 15 also includes the subject matter according to any one of examples 11-14, above.

The insulating coating comprises Ca_{0.5(1+x)}FeₓTi₂₋ₓ(PO₄)₃ where x is between 2.5 and 0. The preceding subject matter of this paragraph characterizes example 16 of the present disclosure, wherein example 16 also includes the subject matter according to any one of examples 11-15, above.

The insulating coating is applied by solution spray process or a suspension spray process. The preceding subject matter of this paragraph characterizes example 17 of the present disclosure, wherein example 17 also includes the subject matter according to any one of examples 11-16, above.

The insulating coating is applied by solution spray process or a suspension spray process. The preceding subject matter of this paragraph characterizes example 18 of the present disclosure, wherein example 18 also includes the subject matter according to any one of examples 11-17, above.

An input of the insulating coating comprises a liquid stock. The preceding subject matter of this paragraph characterizes example 19 of the present disclosure, wherein example 19 also includes the subject matter according to any one of examples 11-18, above.

The liquid stock is made by a soluble metal/metalloid compound and phosphates are mixed in a solvent and then used in a deposition process. The preceding subject matter of this paragraph characterizes example 20 of the present disclosure, wherein example 20 also includes the subject matter according to any one of examples 11-19, above.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a schematic diagram illustrating an embodiment of a thermal barrier coating in accordance with one or more embodiments of the present invention;

FIG. 2 depicts a schematic diagram illustrating an embodiment of a thermal barrier coating in accordance with one or more embodiments of the present invention;

FIG. 3 depicts a schematic diagram illustrating an embodiment of a substrate with an insulating thermal spray coating in accordance with one or more embodiments of the present inventions; and

FIG. 4 depicts a flow chart diagram of a method for forming a thermal barrier coating in accordance with one or more embodiments of the present invention.

Throughout the description, similar reference numbers may be used to identify similar elements.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

As discussed above, automobile and truck IC engines dominate the ground transportation sector in the US (and globally), annually transporting 11 billion tons of freight and logging 3 trillion vehicle miles. Improvement to the fuel efficiency of IC engines reduces environmental impact and can yield large economic benefits, both to the end users (i.e., the operators of IC engine powered vehicles) and to the competitiveness of engine manufacturers across the world. Although U.S. federal regulations currently incentivize electric vehicles and the penetration of electric vehicles is expected to increase in the future, IC engines are anticipated to remain as the primary energy conversion technology in vehicle application to 2040 and beyond in nearly all projections.

In IC engines, a large fraction of the heat generated during combustion is transferred to the pistons, the head, and the cylinder liner, and ultimately dissipated by the engine coolant. These direct heat losses to the combustion chamber walls reduce the power generated, and consequently, the efficiency of IC engines. TBCs can be used to address this issue. By coating the engine components that define the combustion chamber with TBCs, heat losses can be substantially reduced, thereby providing higher temperatures and pressures after combustion and throughout expansion. The higher pressures during expansion increase work extraction improving thermal efficiency. In addition, low thermal inertia TBCs provide rapid surface temperature response which will reduce time to catalyst light-off, resulting in lower unburned hydrocarbon (UBHC) and carbon monoxide (CO) emissions during a cold-start. Embodiments described herein provide the above enhanced improvements.

The use of high-performance TBCs have resulted in up to 2% relative improvement in thermal efficiency along with reduced UBHC emissions. Such results were achieved by applying embodiments described herein of an advanced TBC to the piston surface only. Efficiency benefits are amplified even more by coating the remaining combustion chambers surfaces in addition to the piston and other components of the internal combustion engine.

TBCs in IC engines have been tested in the past, as early as the 1980s, in diesel engines, with the goal of duplicating the successful use of TBCs in gas turbines. This resulted in the concept of the adiabatic engine, where the basic premise was that insulating the combustion chamber would reduce heat rejection and consequently increase work generated by the cycle. Very thick ceramic coatings (in most cases, yttria-stabilized zirconia, YSZ) were applied to the cylinder head, and the top of the piston. However, this approach was largely unsuccessful due to four fundamental flaws:
(1) the thick coatings stored heat, creating high surface temperatures throughout the cycle, which negatively impacted volumetric efficiency (i.e., charge heating),
(2) most of the energy saved by reducing heat losses transitioned to exhaust losses rather than usable work,
(3) the coatings had poorly matched coefficients of thermal expansion (CTE) compared to the piston which led to premature failure, and
(4) the coatings were porous, and therefore absorbed and desorbed UBHC, which increased the TBC thermal conductivity and UBHC emissions.

Embodiments of the invention described herein differ significantly by elevating wall temperatures only when it matters most, i.e. during combustion and expansion, thus avoiding these negative effects.

Adoption of embodiments described herein can have broad impacts on the engines for the 80 million light-duty vehicles made worldwide. Based on spark ignition (SI) engine characteristics, the heat transfer and efficiency improvements can be realized at low to medium loads and speeds where SI efficiency is particularly low. Furthermore, such coatings also increase the exhaust gas temperatures for potential secondary energy recovery—for example, turbocharging or by utilizing emerging thermal electric technology. In addition, the propensity to knock is a unique challenge in SI engine applications; however, our approach enables us to both improve thermal efficiency and address end-gas knock, as described herein.

In components that experience large temperature changes coatings need to reasonably match the expansion behavior of the substrate. For metal components of IC (internal combustion) engines this includes valves and exhaust components and for gas turbines this includes all hot section parts such as vanes, turbine blades, combustor components and ducts. A class of high temperature materials referred to as “NZP”-type ceramics were named after the first discovered member of this group [NaZr₂(PO₄)₃]. In this class of ceramics, for the ones with 2 metallic elements there are hundreds of potential compounds, and if 3 metallic elements there will be many thousands of potential combinations. Some representative bulk materials from this class are well illustrated in literatures.1 This class of ceramics was primarily developed to have low coefficients of thermal expansion (CTE) typically below 4 ppm/C. However, there are a number of materials from this class that have higher CTEs in the range of 7 ppm/C or above. Here as a supplement to our U.S. Pat. No. 11,434,816 we propose to extend the application to IC engines to include materials for valve TBCs with CTE greater than 5 ppm/C as covered in U.S. Pat. No. 11,434,816. In addition we propose to cover the use of high-CTE NZP ceramics for gas turbine hot parts. Such high-CTE NZP ceramic coatings can be applied to the target surface using a dip-coating/panting method followed by subsequent heat treatment for a thin layer, or thermal spray methods for fast deposition of coatings with a low thermal conductivity. 1 V. I. Pet'kov, E. A. Asabina, Glass Ceram., 61 (7-8), (2004) 233-239.

Previous work on thick TBCs found that higher surface temperatures increased the propensity for end-gas knock. However, if the thermal conductivity and heat capacity of a TBC are low enough, it is possible to actually reduce the surface temperature during intake and compression compared to a bare-metal surface which reduces the risk of knock. Embodiments described herein include temperature swing TBCs with appropriate properties can simultaneously improve efficiency and reduce the propensity to knock.

Additionally, a low thermal inertia coating, as embodiments herein include, can reduce emissions during cold-starts. A large fraction of the UBHC and CO emissions during a standard EPA test can be attributed to the first 60 seconds of operation. After that initial period, the catalytic converter achieves the light-off temperature and begins reacting and reducing all but trace amounts of emissions. TBCs have much lower thermal inertia than steel or aluminum, thus producing high surface temperatures soon after a cold-start along with reducing heat transfer losses, both of which will reduce the time to catalyst light-off and the cold-start emissions. Embodiments described herein improve cold-starts and improve catalytic effects of TBCs, especially on the exhaust valves, which is particularly useful in cold-starts.

Most gasoline engines in light-duty vehicles have aluminum pistons, engine blocks, and cylinder heads driven primarily by weight savings. The Al components have relatively high coefficients of thermal expansion (CTE) in the range of 20-25×10⁻⁶/° C. Computational work has identified a path to reducing critical stresses in the coating by matching the CTE between the TBC and the substrate. The most widely used TBC material in gas turbines has been YSZ with a CTE of ˜11×10⁻⁶/° C., which is a significant mismatch compared to the substrate (aluminum) and resulted in poor durability. The majority of initial attempts at TBCs for IC engines used materials borrowed from the gas turbine industry (e.g. YSZ) requiring operating temperatures up to at least 1200° C. The operating temperatures of the SI engine are much lower, typically below 500° C. A wide range of new coating materials with more favorable properties that still exceed the 500° C. limit, but fall short of the 1200° C. Unlike gas turbines, for IC engines where temperature swing is critical and so (e.g. SI engines), minimizing thermal inertia is paramount. Thermal inertia (also referred to as effusivity, which appears in the analytical solution to transient heat transfer problems with a periodic heat flux) is defined as the square root of the product of thermal conductivity and volumetric heat capacity. It is commonly understood that both low thermal conductivity and low volumetric heat capacity are desired; thermal inertia captures the effects of both properties in a single quantity. Therefore, a new class of coating materials was required for new temperature-swing TBCs materials for SI engines, and the selection criteria were: (1) low thermal inertia (minimize k·ρ·cₚ), (2) CTE as close to 20-25×10⁻⁶/° C. as possible, and (3) service temperature up to 500° C.

Two compositions of perovskites were explored. First, La_{0.6}Sr_{0.4}Co₁₋ₓFeₓO₃ (LSCF) with x=0.4 was identified. It has a reported CTE of 16.7×10⁻⁶/° C., and a bulk thermal conductivity in fully dense form at 500° C. of approximately 1.4 W/mK when x=0.4 yielding an effusivity of 1048 J/m²-K-s^{1/2}. This is nearly a 2× reduction in effusivity compared to YSZ (1995 J/m²-K-s^{1/2} at 500° C.). In addition, another candidate was identified in perovskite: 6 mol % bismuth-doped La₂Mo₂O₉ (Bi-LMO) with a reported fully dense thermal conductivity of 0.66 W/m-K and a coating effusivity of 620 J/m²-K-s^{1/2} which is more than 40% lower than LSCF, 3× times lower than YSZ, and 2× lower than the highest performing coatings of GZO (effusivity of 1364 J/m²-K-s^{1/2}). After processing and testing in motorcycle and automobile engines, Bi-LMO was down-selected due to its good durability in engine tests including associated water vapor and oil contaminants and its exceptionally low thermal inertia. This material is also stable up to at least 1000° C., and therefore, higher temperatures due to larger temperature swing in an SI engine will not be an issue.

In some embodiments, only piston crowns are coated. In some embodiments, other components including the cylinder head, valve faces, and the fillet and lower stem of the intake and exhaust valves are coated. Coating additional components is guaranteed to further reduce heat loss and increase efficiency. In some embodiments, the firedeck is coated which can provide additional improvements.

Embodiments of this invention relate to thermal barrier coatings in internal combustion engines.

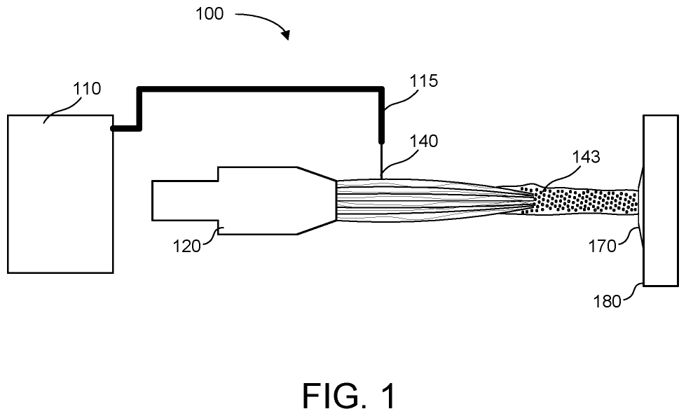

Referring to FIG. 1, a schematic diagram 100 of a spray coating is depicted. The spray coating is applied through an air plasma spray (APS) process involving the injection of powder in a plasma plume. Although shown and described with certain components and functionality, other embodiments may include fewer or more components to implement less or more functionality. The schematic diagram includes a plasma gun 120 configured to spray a plasma. Also depicted is a powder feeder 110 and feed port 115 that is configured to feed a powder 140 precursor into the plasma spray which sprays particles 143 (sometimes molten particles) onto the substrate 180 which forms an insulating thermal spray coating 170 on the substrate.

The substrate 180 may be any component part of an internal combustion engine including but not limited to a piston crown, a combustion chamber, a valve face, an exhaust port, an exhaust manifold section, a firedeck, etc. The insulating thermal spray coating 170 may be applied to a single component or surface of an internal combustion engine or up to an entirety of an internal combustion engine.

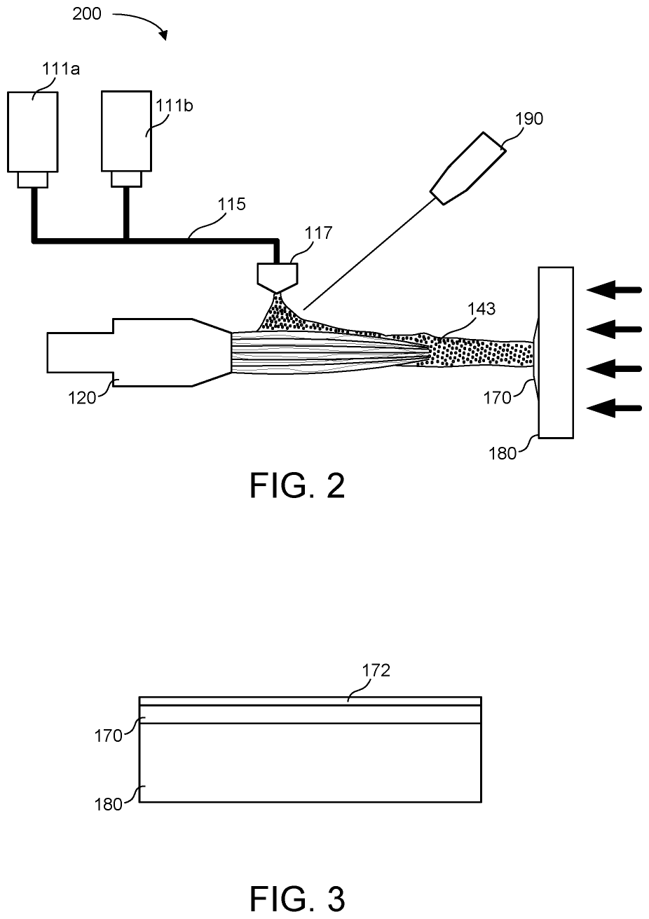

Referring to FIG. 2, a schematic diagram 200 of a spray coating is depicted. The spray coating is applied through a solution precursor plasma process (SPPS). Although shown and described with certain components and functionality, other embodiments may include fewer or more components to implement less or more functionality. The schematic diagram includes a plasma gun 120 configured to spray a plasma. Also depicted are liquid reservoirs 111a and 111b which are fed via feed port 115 and injector 117 into the plasma spray. The droplets 143 are applied to the substrate 180 to form an insulating thermal spray coating 170 or just coating. Also depicted are arrows that represent a temperature control that may be applied to the substrate 180. The system may also include a monitoring device 190 that is configured to monitor the injection process.

The SPPS process injects a solution precursor into the plasma plume in place of powder used in the APS process. The SPPS process is used to rapidly spray and test new coating compositions, which allows the quick and efficient spray application of new compositions. The alternative APS process requires powders of specific size distributions to be made which takes 2 to 3 months to make per batch. This is a time consuming and expensive process when compositions have to be modified during exploratory development work.

Extensive work has been conducted since the 1980's on TBCs in automotive and truck engines, with emphasis on diesel engines. This work can be sub-divided into two distinct categories. First, the early work in the 1980s attempted to prove that the “adiabatic engine” will enable improved efficiency by eliminating heat losses. As already discussed, this hypothesis was disproven. The second category, comprised of more recent work described herein, reflects the realization that the surface “temperature-swing” effect can produce the desired heat loss reduction when it matters most, i.e. during combustion and expansion, without the negative effects on charge heating. Temperature-swing TBCs have demonstrated increased expansion work and improved thermal efficiency. These coating also increase exhaust temperature along with increasing the extracted mechanical work. Hotter exhaust can benefit after-treatment and turbochargers.

Although occasional improvements in fuel consumption, engine durability, engine power, and emissions have been reported, much of the previously published work is for diesel combustion and TBCs have not been thoroughly investigated for SI combustion.

In production operations, deposition rate dictates the number of parallel spray facilities required for the desired through-put, which directly impacts capital cost. In addition, the robustness of the process and the minimization of defects becomes critical to lowering production costs. The deposition rate for the APS process is at least 3× higher than SPPS due primarily to the energy and heat transfer needed to evaporate the solvent. Furthermore, the powder spray process has much greater tolerance (>4×) to variations in the standoff distance between the spray gun and the part (preliminary results summarized in Section 3). Modern pistons have complex surface topography. Abrupt changes in surface height, along with a spray pattern that is about 1.5 cm wide, present significant challenges in coating uniformity when using the SPPS process due to its sensitivity to standoff distances. APS's relative tolerance to standoff distance allows closer-to-ideal coating microstructures over the entire surface of the part when spraying complex topographies. Finally, APS powder spray leads to a more ideally melted coating because unmelted particles generally do not stick in powder spray, whereas in the SPPS process if liquid precursor arrives it will stick as unpyrolyzed droplets which undergo further pyrolysis on the substrate. In our Phase I work (Section 3), we have shown that powder spray leads to harder coatings that are potentially more durable. As a result, a major thrust of Phase II will be developing the powder-based APS process for these applications. The main challenges will be achieving the desired surface smoothness and compensating for selective element loss as discussed herein.

The SPPS process has shown great success in making thick coatings used as thermal barriers for gas turbine applications, nano-composite preforms for transparent missile window applications, and thin, dense coatings for a variety of applications, including internal combustion engines. The SST/UConn Group has generated over fifty relevant publications and has extensive experience in deposition of a number of metal oxide coatings, including YSZ, Al₂O₃/ZrO₂ composites, Al₂O₃, TiO₂, GZO, and yttrium aluminum garnet (YAG) for a variety of applications such as gas/aero turbines, biomass combustors, SOFCs, and naval/marine corrosion protection done using the APS process.

The SPPS TBC application that have generated considerable interest in the gas turbine industry: SPPS YSZ TBCs with much reduced thermal conductivity and improved cyclic durability, and SPPS YAG TBCs with a 200° C. temperature advantage over the current engine standard APS YSZ. The technology is now being transitioned to commercial readiness and has developed and demonstrated TBCs for diesel engines. The team has previously completed work that demonstrates significant thermodynamic efficiency improvements of 3-5% on a relative basis for HCCI engines, through the use of relatively thin TBCs applied to the piston crown.

We have increased the technology readiness level (TRL) of the new Bi-LMO coatings by demonstrating cost reduction and the largest improvement in fuel efficiency and emissions for both steady state and cold-starts, by convincingly proving coating durability, and by demonstrating a path toward price competitiveness.

Some embodiments coat pistons, but also coat other engine components, including valve faces and the cylinder heads. Coating additional surfaces exposed to hot combustion gases is a way to increase the performance benefits as we have observed in our diesel engine work. The selection of additional components may be based on detailed finite element analysis and coupled thermodynamic modeling studies conducted at Clemson to determine which components provide the largest efficiency gain and to determine an optimal coating thickness for each component. The APS process of depositing Bi-LMO coatings is used due to its greater deposition rate (3X minimum), for cost reduction. The APS process is optimized to reduce costs and improve process reliability. From an implementation perspective, three types of interlinked activities are: 1) thermal spray coating optimization, 2) modeling to optimize thickness for each type of component and predict the relative impact of coatings on each type of component, and 3) engine testing to provide the data needed to motivate commercial adoption. Modeling and engine testing helps to guide the tradeoffs and down-selection of the properties that result from microstructure variations due to spray process variations. Modeling will be especially useful in determining the relative benefits of coating different hot section components. Knowing each component's relative importance is useful for engine manufacturers in deciding which, and how many, components to coat. Modeling illuminates the important coating tradeoffs include durability versus lower conductivity and/or roughness, choosing the ideal thickness, and any difference in performance between cold-start requirements versus steady state.

Embodiments use APS for its advantages over the SPPS process. Accordingly, multiple spray trials mapped-out and optimized the new process and illuminate the structure-properties relationship. This effort involves hardness measurements, microscopy to reveal microstructure, density measurements, deposition efficiency, deposition rate determination and thermal conductivity measurements. The ability to make various coatings allows the down-selection of different possible coating characteristics. The choice of coating thickness is important because thicker coatings are more expensive, store more strain energy potentially affecting durability, and have the potential to lead to more intake charge heating. On the other hand, higher thicknesses increase temperature swing up to a certain thickness. Modeling will provide vital guidance for this choice before validation is ultimately obtained from engine tests.

A second aspect of the coating properties that affects performance is surface roughness which showed that smoother surfaces improved performance. Roughness was routinely measured and is a candidate for optimization because spray parameters will influence roughness. Specifically, using smaller powder particles and as normal spray arrival angle as possible minimize surface roughness. In addition to directly helping cold start emissions, our low thermal inertia coatings reduce time to catalyst light-off and reduce cold-start emissions. Additionally, in some embodiments, thin surface catalyst coatings reduce cold-start emissions.

Economics of the deposition process will be enhanced by achieving repeatability of microstructure and consistency of microstructure over the complex part geometries. The process is reliable enough to minimize inspection requirements. Economics are also strongly affected by deposition rate and deposition efficiency.

Some embodiments include optimizing the characteristics needed for a particular performance of an engine. Variations of materials described herein provide different benefits. Options can be down-selected depending on the weighing factors that are most meaningful to the application.

Fuel economy enhancement depends primarily on temperature swing, because higher wall temperatures reduce the temperature difference between the wall and combustion gases and hence reduce convective heat loss to the wall. Higher wall and gas temperatures can also reduce UBHCs and provide hotter exhaust gases for aftertreatment. Finally, rapid wall temperature rises will reduce cold-start emissions. These factors must be optimized in consideration with intake charge preheating and stresses within the coating. This can be improved by the choice of an optimal coating thickness, which will be done by first modeling and then testing more than one thickness. The modeling work encompasses detailed, material modeling using both commercial and custom finite element analysis (FEA) solvers for the temperatures within the TBC. These FEA codes will be coupled to 0D/1D thermodynamic modeling of the engine cycle as well as 3D Computational Fluid Dynamics (CFD) modeling to determine the heat fluxes experienced by various engine components as well as the effects of temperature-swing TBCs on the thermal efficiency, exhaust temperature, and emission formation. The relative benefit of coating different components determined from modeling is an important part of system optimization.

The coating technology developed described here are a key technology for the improved performance of IC engines in terms of increased overall engine efficiency and reduced exhaust emissions. Considering that IC engines dominate the US ground transportation market and are expected to continue to do so for the foreseeable future, this technology will bring significant environmental and economic benefits, such as:

Energy efficiency. The 3% improvement in efficiency of IC engines will conserve a significant amount of fuel if applied to the US light-duty vehicle fleet, bringing economic benefits to the US consumers as well as environmental advantages of decreased carbon emissions.

Reduced toxic exhaust. Due to the low thermal inertia of the TBCs, the rapid temperatures change on the coating surface during cold-starts will reduce time to catalyst light-off, thereby reducing undesirable UBHC, CO emissions, and NOx emissions during a cold-start.

The competitiveness in manufacturing. Developing more efficient and environmental-friendly IC engine technology will enhance the overall competitiveness of engine manufacturers in global markets.

Energy security. The conservation of fossil fuel enabled by this novel coating technology in IC engines will strengthen energy independence of countries.

Some embodiments include significant thermal efficiency improvements that have been demonstrated for a compression ignition gasoline engine (homogeneous charge compression ignition (HCCI)) by the application of a thermal barrier coating (TBC) on the piston crown. This is accomplished by a temperature swing that reduces heat loss during the ignition part of the cycle but cools fast enough to avoid significant intake charge preheating. The desired properties of the coating are low thermal energy storage and, hence, low mass density and specific heat, low thermal conductivity and sufficient strength to withstand the pressure excursion and thermal shock. In addition, it has been shown that coating surface smoothness is important. The ideas presented herein are applicable to all gasoline compression ignition engines including but not limited to HCCI engines, diesel engines, and conventional spark ignition engines. It is recognized that aluminum engine parts have radically different thermal expansion coefficients (20+PPM/° C.) vs. steel and cast iron (roughly 9-11 ppm/° C.) and the optimal coating choices will differ by engine material type and, in addition, the heat flux and, hence, thermal shock and the pressure pulse are much higher in diesel engines than other engines.

Embodiments of inventions described herein relate to a series of novel materials choices and material application methods to produce superior IC engine coatings. In some embodiments, these coatings may be applied by the thermal spray process. The thermal spray process includes plasma spray, high velocity oxygen fuel spray, flame spray, detonation gun spray and vacuum and inert environment plasma spray. Because the metal in IC engines are aggressively cooled, the difference in thermal expansion coefficient between the coating and the metal, although still important, is less important than in gas turbines.

Thermal spray (TS) can be done by the following spray technologies, Plasma spray, high velocity oxygen fuel spray (HVOF), subsonic oxygen fuel spray, air fuel spray often called flame spray and detonation gun spray. In embodiments of this invention, thermal spray is to be defined to specifically include any or all of these technologies. In addition, the materials can be delivered to the thermal spray torch in three different forms, as a powder (PS), as a suspension of the material (SP), and as chemical precursors that form the final materials in reactions occurring in the thermal spray plume (PR). PR specifically includes but is not limited to solution precursor plasma spray (SPPS) Each of the materials below is to be applied by any TS method using delivery to include PS, SP and PR except as noted.

Referring to FIG. 3, a schematic diagram illustrating an embodiment of a substrate 180 with an insulating coating or insulating thermal spray coating 170 is depicted. In the illustrated embodiment, the substrate 180 is a component or portion of an internal combustion engine or a gas turbine. The thermal barrier coating includes an insulating coating 170, where a chosen material of the insulating coating includes one of a sodium zirconium phosphate (“NZP”) class of ceramics that has a coefficient of thermal expansion (“CTE”) greater than 5 ppm/C.

In some embodiments, the insulating coating is applied by a thermal deposition comprising one of plasma spray, flame spray, high velocity oxygen fuel spray, detonation gun spray, dip coating, or painting.

In some embodiments, an input of the insulating coating comprises one of powder or ingots.

In some embodiments, the insulating coating is applied by one of radio frequency (RF) sputtering deposition, or electron beam physical vapor deposition.

In some embodiments, the insulating coating comprises one of NaGe₂(PO₄)₃ and NaGe₂₋ₓTiₓ(PO₄)₃ with x between 0 and 1. In some embodiments, the x is between 0.25 and 0.5.

In some embodiments, the insulating coating comprises Ca_{0.5(1+x)}FeₓTi₂₋ₓ(PO₄)₃ where x is between 2.5 and 0.

In some embodiments, the insulating coating is applied by solution spray process or a suspension spray process.

In some embodiments, the insulating coating is applied by solution spray process or a suspension spray process.

In some embodiments, the liquid stock is made by a soluble metal/metalloid compound and phosphates are made into two separate aqueous solutions that are mixed before use to avoid gelation.

In some embodiments, the substrate is a component of a gas turbine. In some embodiments, insulating coating is applied to hot section components of the gas turbine where the hot section components are made of superalloys. In some embodiments, a chosen material of the insulating coating comprises sodium zirconium phosphate (“NZP”) class of ceramics that have a coefficient of thermal expansion (“CTE”) greater than 5 ppm/C.

In some embodiments, the superalloys are nickel-based superalloys. In some embodiments, the hot section components comprise one of vanes, blades, combustors, or ducts.

In some embodiments, the insulating coating is applied by one of radio frequency (RF) sputtering deposition, or electron beam physical vapor deposition.

In some embodiments, the insulating coating comprises one of NaGe₂(PO₄)₃ and NaGe₂₋ₓTiₓ(PO₄)₃ with x between 0 and 1. In some embodiments, the x is between 0.25 and 0.5.

In some embodiments, the insulating coating comprises Ca_{0.5(1+x)}FeₓTi₂₋ₓ(PO₄)₃ where x is between 2.5 and 0. In some embodiments, the x is between 0 and 1.

In some embodiments, the insulating coating is applied by solution spray process or a suspension spray process.

In some embodiments, an input of the insulating coating comprises a liquid stock. In some embodiments, the liquid stock is made by a soluble metal/metalloid compound and phosphates are mixed in a solvent and then used in a deposition process.

In some embodiments, superalloys include nickel based superalloys. In some embodiments, superalloys include cobalt based superalloys. In some embodiments, superalloys include steel superalloys. In previous research regarding the NZP's, they have not been used with superalloys in gas turbines. Embodiments described herein overcome limitations and show advanced properties for coating superalloys in gas turbines.

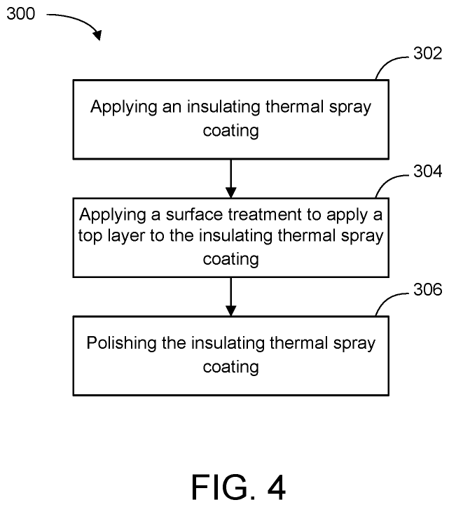

Referring now to FIG. 4, a method 300 for forming a thermal barrier coating is disclosed. The method includes applying 302 an insulating thermal spray coating where a chosen material of the insulating thermal spray coating has a chosen material including a sodium zirconium phosphate (“NZP”) class of ceramics that have a coefficient of thermal expansion (“CTE”) greater than 5 ppm/C is placed. At block 302, a surface treatment applies a top layer to the insulating thermal spray coating. At block 304, the insulating thermal spray coating is polished. The method then ends. Some embodiments may include only one or two of the depicted steps.

Although the foregoing disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The present subject matter may be embodied in other specific forms without departing from its spirit or essential characteristics. The described embodiments are to be considered in all respects only as illustrative and not restrictive.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity

What is claimed is:

1. A thermal barrier coating for an internal combustion engine, comprising:
an insulating coating applied on engine valves and exhaust components, wherein:
a chosen material of the insulating coating comprises a material of a sodium zirconium phosphate (“NZP”) class of ceramics that has a coefficient of thermal expansion (“CTE”) greater than 5 ppm/C.

2. The thermal barrier coating of claim 1, wherein the insulating coating is applied by a thermal deposition comprising one of plasma spray, flame spray, high velocity oxygen fuel spray, detonation gun spray, dip coating, or painting.

3. The thermal barrier coating of claim 1, wherein an input of the insulating coating comprises one of powder or ingots.

4. The thermal barrier coating of claim 1, wherein the insulating coating is applied by one of radio frequency (RF) sputtering deposition, or electron beam physical vapor deposition.

5. The thermal barrier coating of claim 1, wherein the insulating coating comprises one of NaGe₂(PO₄)₃ and NaGe₂₋ₓTiₓ(PO₄)₃ with x between 0 and 1.

6. The thermal barrier coating of claim 1, wherein the insulating coating comprises Ca_{0.5(1+x)}FeₓTi₂₋ₓ(PO₄)₃ where x is between 2.5 and 0.

7. The thermal barrier coating of claim 5, wherein the insulating coating is applied by solution spray process or a suspension spray process.

8. The thermal barrier coating of claim 6, wherein the insulating coating is applied by solution spray process or a suspension spray process.

9. The thermal barrier coating of claim 1, wherein an input of the insulating coating comprises a liquid stock.

10. The thermal barrier coating of claim 9, wherein the liquid stock is made by a soluble metal/metalloid compound and phosphates are made into two separate aqueous solutions that are mixed before use to avoid gelation.

11. A thermal barrier coating for a gas turbine, comprising:
an insulating coating applied to hot section components of the gas turbine made of a superalloy, wherein:
a chosen material of the insulating coating comprises a material of a sodium zirconium phosphate (“NZP”) class of ceramics that has a coefficient of thermal expansion (“CTE”) greater than 5 ppm/C.

12. The thermal barrier coating of claim 1, wherein the superalloy is a nickel-based superalloy.

13. The thermal barrier coating of claim 1, wherein the hot section components comprise one of vanes, blades, combustors, or ducts.

14. The thermal barrier coating of claim 1, wherein the insulating coating is applied by one of radio frequency (RF) sputtering deposition, or electron beam physical vapor deposition.

15. The thermal barrier coating of claim 1, wherein the insulating coating comprises one of NaGe₂(PO₄)₃ and NaGe₂₋ₓTiₓ(PO₄)₃ with x between 0 and 1.

16. The thermal barrier coating of claim 1, wherein the insulating coating comprises Ca_{0.5(1+x)}FeₓTi₂₋ₓ(PO₄)₃ where x is between 2.5 and 0.

17. The thermal barrier coating of claim 5, wherein the insulating coating is applied by solution spray process or a suspension spray process.

18. The thermal barrier coating of claim 6, wherein the insulating coating is applied by solution spray process or a suspension spray process.

19. The thermal barrier coating of claim 1, wherein an input of the insulating coating comprises a liquid stock.

20. The thermal barrier coating of claim 19, wherein the liquid stock is made by a soluble metal/metalloid compound and phosphates are mixed in a solvent and then used in a deposition process.
